(19) United States
(12) Patent Application Publication
(10) Pub. No.: US 2010/0333094 A1
(43) Pub. Date: Dec. 30, 2010

(54) JOB-PROCESSING NODES SYNCHRONIZING JOB DATABASES

(76) Inventors: Mark Restall, Bristol (GB); Keir D. Shepherd, Bristol (GB)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/490,450

(22) Filed: Jun. 24, 2009

(51) Int. Cl. G06F 9/46

(52) U.S. Cl. 718/102

(57) ABSTRACT

A first node of a network updates a first job database to indicate that a first job is executing or is about to be executed on the first node. Network nodes are synchronized so that other nodes update their respective job databases to indicate that the first job is executing on said first node.

### BACKGROUND

Herein, related art is described for expository purposes. Related art labeled “prior art”, if any, is admitted prior art; related art not labeled “prior art” is not admitted prior art.

The challenge of effectively allocating computational jobs to computation nodes can be addressed using a centralized job manager to monitor job queue length at available nodes and the allocating jobs to the nodes with the shortest job queues. Alternative parameters, e.g., node performance, node health, etc., can be considered instead of or in addition to queue length.

### BRIEF DESCRIPTION OF THE DRAWINGS

FIG. 1 is a schematic diagram of a geographically distributed computer system providing for distributed allocation of jobs to nodes in accordance with an embodiment.

FIG. 2 is a combination schematic diagram and flow chart in accordance with embodiments.

### DETAILED DESCRIPTION

Provided for herein is a decentralized allocation of jobs to nodes that can be tolerant of slow and unreliable network connections, tolerant of job and node failures, and is readily scalable to large numbers of nodes and jobs. Each node maintains a table of jobs and associated information. Each table lists all jobs, including jobs that are assigned to other nodes. The nodes broadcast and receive job status updates to and from other nodes so that the tables can be synchronized. Despite the lack of centralized management, job allocation is coordinated because independently acting nodes make determinations using synchronized data.

The synchronization process is itself asynchronous in that nodes may receive job status updates at different times due to differential communication latencies. This can cause two nodes to claim the same failed job and begin duplicate executions as separate jobs on the respective nodes. Each node includes a duplicate job remover that scans the local job table to detect job duplication and abort jobs that are likely (as determined from the local job table) to be completed sooner by another node.

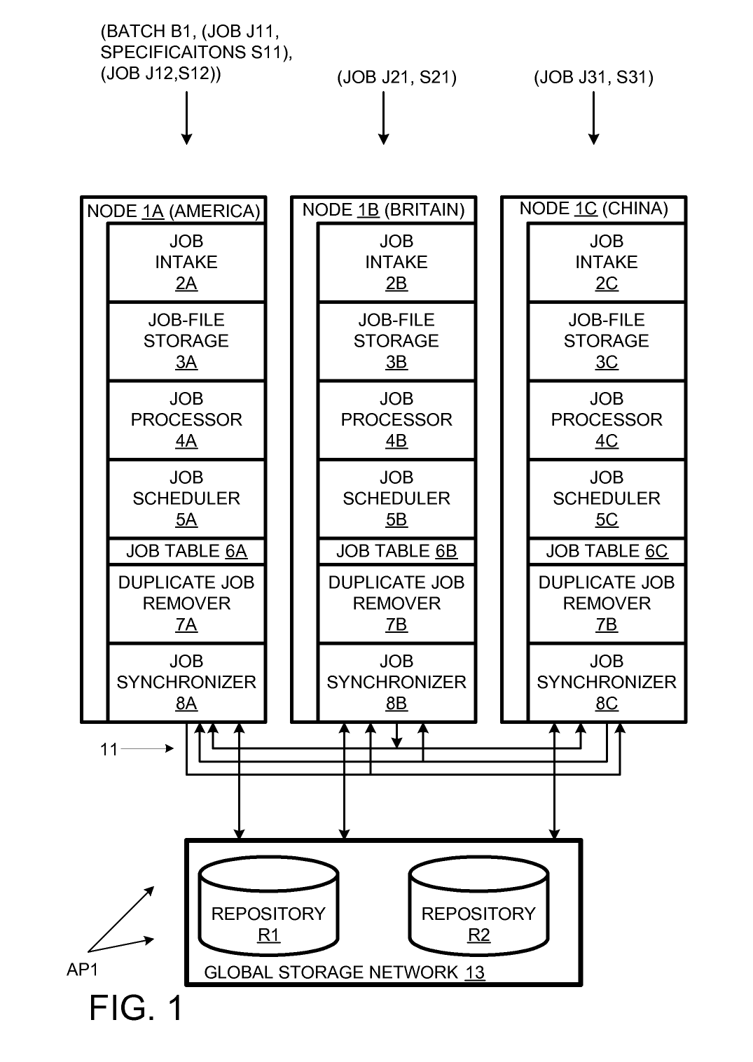

A system AP1 in accordance with an embodiment is shown in FIG. 1 having three nodes 1A, 1B, and 1C, a computer communications network 11, and a global storage network 13. The indicated geographical locations, America, Britain, and China, respectively, for nodes 1A, 1B, and 1C have been selected for expository purposes to emphasize that the job allocation scheme is well suited for intercontinental communications systems. Other geographic locations can be selected. Also, the distributed job allocation scheme is scaleable to accommodate systems with a single node, two nodes, three nodes, or any other number of nodes.

Nodes 1A, 1B, and 1C can communicate with repositories R1 and R2 of global storage network 13 for reading and writing job file data. As with the nodes, the repositories can be distributed globally. In some embodiments, all job data is stored in the job-file storage of the nodes. However, in system AP1, computation and storage are distributed independently. Thus, job file storage 3A, 3B, and 3C function as repository caches for job files as they are or are about to be processed. Alternative embodiments provide for other numbers and topologies of repositories.

Node 1A includes a job intake 2A, a job-file repository 3A, a job processor 4A, ad job scheduler 5A, a job table 6A, a duplicate job remover 7A, and a job synchronizer 8A. Comparable components are included in each node of system AP1. For example, node 1B includes a job intake 2B, a job-file repository 3B, a job processor 4B, a job scheduler 5B, a job table 6B, a duplicate job remover 7B, and a job synchronizer 8B. Likewise, node 1C includes a job intake 2C, a job-file repository 3C, a job processor 4C, a job scheduler 5C, a job table 6C, a duplicate job remover 7C, and a job synchronizer 8C. Other nodes added to system AP1 will have analogous components. In other respects, the nodes of system AP1 can differ, e.g., in computing capacity, storage capacity, and communications bandwidth.

One type of job handled by system AP1 is a long running job, which for example could be, video processing, e.g., reformatting, compressing, and decompressing video data. Job files and any associated specifications can be input to any node of system AP1. For example, a job J1 input to node 1A is handled by job intake 2A, which stores the data to be manipulated in job-file storage 3A and in repositories R1 and R2. In addition, job intake 2A creates a new entry in job table 6A for each new job received. Each job is assigned a job identifier (ID) in the table. Other data associated with each job in job table 6A is detailed further below.

Job schedulers 5A-C scan respective tables 6A-6C to determine the order in which jobs are to be executed. For example, job scheduler 5A can scan job table 6A to determine which jobs are executed first. Alternatively, job scheduler 5A can deviate from this order by implementing policies that give jobs different priority weightings. For example, a later filed high priority job may be executed before a low priority job. Also, a job on which other jobs depend may be executed earlier than an independent job. In such cases, a job scheduler can determine priority weightings from data associated with a job in the respective job table.

Each job table lists not only jobs submitted to the incorporating node, but jobs submitted to all nodes. For example, job table 6A lists jobs submitted to nodes 1B and 1C as well as to node 1A. To this end, job synchronizers 8A-C communicate with each other over computer network 11 to synchronize tables 6A-6C. “Synchronize” herein refers to updating each table with data from the other tables. For example, synchronizer 8A can broadcast status of the jobs running on node 1A only in table 6A to nodes 1B and 1C. If job J1 is not already represented in job table 6B, job synchronizer 8B will create a new record for job J11 duplicating the information stored about the job. However, associated with this job ID for node 1B is an identification of node 1A as the originating node for job J1 and the job ID assigned to job J1 in job table 6A. As job 1J11 progresses from “pending” to “executing” status on node 1A, synchronizer 8A broadcasts this status update, which can thereby be reflected in tables 6B and 6C.

While some jobs are processed at the originating node, others are not. For example, job J21 may be submitted to node 1B. However, the specifications S2 for job J21 may specify that the job is to be processed on node 1A. For example, node 1A may be specified because it has access to a piece of software e.g. video codec (coder-decoder) that is not available to node 1B. To accommodate such specifications, each table 6A-6C lists both an originating node and associated ID and an executing node and associated ID.

In some cases, the “executing node” will fail to completely process a job file. The job may be retried on the same node until a retry count threshold is met, at which point the job is marked with a failed status. The failure can be due to a hardware failure or general software failure of a node or an incompatibility of a job with the resources of the node. If the associated synchronize is still functioning, it can broadcast a “failed” status for the job to other nodes. If the associated synchronizer has also failed, the other synchronizers will detect the absence of communications or a heartbeat and assume the job has failed. The node tables will then reflect a failed status for the job. A job scheduler can claim and schedule for local processing of a job that the local table indicates has failed on another node. Thus, system AP1 provides for failover job processing.

Because one node's claim to (take responsibility for executing) a failed job may not be immediately communicated to all other nodes, it is possible that two or more nodes claim the same failed job. This duplication is usually undesirable because it wastes resources that could be devoted to processing other jobs that may be pending. However, once the job tables are updated, each table will have duplicate (in that they refer to the same job) entries for the same job.

Duplicate job removers 7A-C can recognize such duplicate entries because they will have the same originating node and originating node ID. A duplicate remover will abort a job on its node if the local start time for processing the job is later than the start time for another node processing the same job; otherwise, processing will continue. This reduces wasted resources due to concurrent processing of the same job. Note that if the problem that caused the original failure is addressed, the associated node may be able to resume processing of the job, in which case, the nodes that took over processing of the job may abort their efforts.

In some cases, a job may not be processable by any node. Tables 6A-C include a claim count field that keeps track of the number of times on which a job has failed and has been re-claimed. When the claim count reaches a threshold, other nodes may not try to process that job. For example, a threshold of two unsuccessful claims (failures) may be set on the assumption that the fault is not with the nodes but with the job file itself.

Some jobs may be related, in which case a batch file/batch entry can specify the relationship between jobs, but all jobs are submitted at the same time. However, some jobs may not start until certain dependencies have been successfully completed. The dependencies may require that all jobs in a batch be processed on the same node or allow concurrent processing on different nodes. For example job J11 is dependent on jobs J10, J9 to be completed. These dependencies are listed in the batch file. In some cases, a failure to process one job in a batch may make it unnecessary or impossible to process one or more other jobs in the batch. Such dependencies can also be specified in a batch file. The identity of a batch file to which a job belongs can be listed in the associated job table. Alternatively, a batch file can be represented in a job table in lieu of the individual jobs of the batch. The associated scheduler can the recognize the batch status of a job and schedule it accordingly. For example, if a job depends on another job that has failed execution, the depending job can also be marked as failed. This will allow both jobs to be assumed by another node.

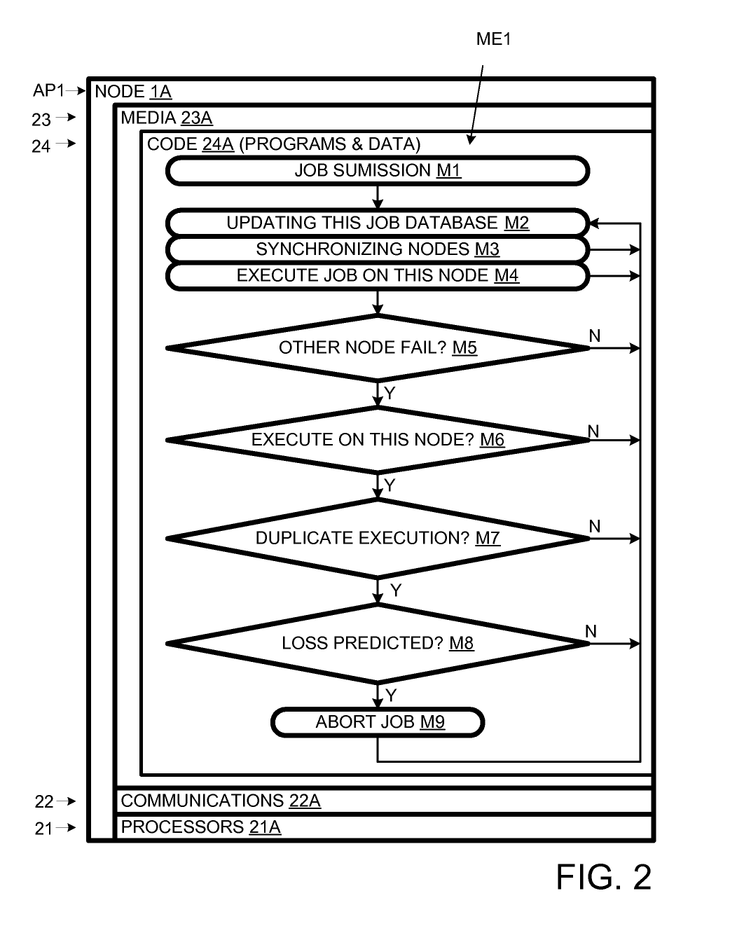

FIG. 2 presents another view of system AP1. System AP1 includes processors 21, communications device 22, and media 23, distributed among nodes 1A-C and global storage network 13. Media 23 includes repositories R1 and R2 (see FIG. 1) and job-file storage 3A-3C. Media 23 is encoded with code 24 defining programs and data, including (see FIG. 1) batch B1, jobs J11-J12, J21, and J31, specifications S11, S12, S21, and S31 (FIG. 1), job intakes 2A-C, job processors 4AC, job schedulers 5A-5C, job tables 6A-C, duplicate job removers 7A-C, and job synchronizers 8A-8C.

The components of node 1A are shown in FIG. 2, it being understood that nodes 1B and 1C have analogous components. Node 1A includes processors 21A, communications devices 22A, and media 23A. Media 23A is encoded with code 24A defining programs and data. Code 24 interacts with processors 21A and communications devices 22A to implement an instance of a method ME1 in accordance with an embodiment. Other instances of method ME1 are executed concurrently on nodes 1B and 1C.

At method segment M1 of method ME1, a job is submitted to node 1A. The job data can be stored in job-file storage 3A and in respositories R1 and R2 (FIG. 1). Job table (database) 6A is updated at method segment M2 to represent the newly submitted job, e.g., job J11. A job ID is assigned to the new job and is associated with information relating to the job as indicated further below.

At method segment M3, job synchronizer 8A transmits job-table, e.g., job-status, update data to other nodes, e.g., nodes 1B and 1C. In turn, job synchronzier 8A can receive updates from nodes 1B and 1C. If an update corresponds to a job that has not been presented in jbob-table 6A, a new job record is made. In most other cases, an old job record is updated. However, since, in system AP1, jobs are identified in part by the source of the update, a new entry may be required for job already entered into table 6a if the update if from a source (e.g., node 8C instead of node 8B) other than the one that caused the record to be established in the first place.

At method segment M4, a job is executed. A newly submitted job may have to wait until previously received jobs have been executed. Depending on the node capabilities, one or more jobs can be executed on a node at once. Note that method segment M2-M4 are operating continuously and have no set order among themselves.

At method segment M5, node 1A and, more specifically, job scheduler 5A determine that job execution has failed on another node. This determination is made by scanning table 5A. For example, node 1B can broadcast to nodes 1A and 1C an update indicating that execution of job 21 has failed. This update is then represented in table 5A so that the failure will be recognize as table 5A is scanned. If the execution failure is due to a failure of node 1B itself, node 1B may be incapable of transmitting an update. In such a case, the other nodes can detect the failure of node 1B, e.g., through a absence of a heartbeat signal. In the case of a detected node failure, it is assumed that all jobs executing on that node have failed as well.

In some cases, a node can begin executing a job at method segment M6, that has failed execution on another node. If so, it updates its table to reflect the fact that it is executing the job that the previous node had been executing. In this situation, duplicate job entries will appear in the local table, e.g., 5A; due to synchronization, entries will also appear in other tables. Of course, if a node has been informed that a node has begun executing a previously failed job, that node will refrain from executing the the job.

However, in some cases two or more nodes may begin executing a failed job. This can happen because synchronization is not instantaneous. There is a period between the time a node (e.g., node 1A) is informed that a job has failed, e.g., on node 1B, and the time it would be informed that a third node, e.g., 1C, had started executing the failed job. If, in that interim, node 1A begins executed the failed job, two (or more) nodes will be executing the same job. This, in general, is considered wasteful.

Duplicate job removers 7A-C address this waste by scanning tables 61-C respectively for duplicate entries indicating concurrent execution at method segment M7. This involves finding all entries with the same originating node and originating job ID. For node 1A, if one entry indicates that the job is executing on node 1A and another indicates that the job is executing on another node, then the entries are compared at method segment M8 to predict which executing instance of the job will finish first (“win”) or which will finish other than first (“lose”). If a loss is predicted at method segment M8, local execution of the job is aborted at method segment M9. If a local win is predicted, execution of the job continues. In this latter case, it is expected that the other executing node will abort execution of the job in view of a loss determination at that node. Note that at method segment M5-M8, a “no” outcome results in a continued execution of whatever job or jobs are being processed.

A network of single or multiple nodes may be connected together. Each node contains a job table that contains the status of all the jobs that exist on all the nodes. The owner of the job automatically broadcasts the state change of the jobs to all nodes within the network.

Jobs may be submitted into an originating node but targeted at a remote node for execution. On arrival the job is assigned a job identifier and originating node identifier. When the jobs arrive at the intended execution node they are assigned a job identifier and the marked with a status of “Pending”. The local autonomous job schedulers will look for pending jobs on the node and then start the job changing the state to “Executing”. The job is executed and once complete the job is marked as “failed” or “completed”. Completion is when successful operation has occurred and failed when some error has occurs. The scheduler reschedules any failed jobs for a maximum of two times before it is marked as “failed”. Failed jobs can be picked up by any node in the network to retry and in doing so they will increment the claim counter. This claiming process creates a new job on another node but still retains the originating node and job identifier. If the claim count reaches “2”, the job is aborted. If more than one job is started as part of a claim process then the node on which it is running will decide whether to abort the job because it started later or based on some other metric.

Each node is autonomous and makes decisions on the jobs that they run in isolation of the other nodes. For example, if communication is lost with another node it is assumed that all jobs on that node have failed and each remote node locally marks those jobs as failed. These jobs are then available to be claimed on the remaining connected nodes. If connectivity is restored then duplicate jobs will exist. A duplicate job removal manager runs continually aborting jobs that may have been claimed, duplicated through poor network connectivity within the system.

Jobs may be submitted as a batch. In practice, all jobs are submitted in parallel but may be assigned dependencies so that they cannot start until one or more jobs have completed. If a job in the batch is aborted, then all jobs in that batch are aborted.

Job tables 6A-C provide for the following fields. “Index” is the local record ID, e.g., a serially assigned record number for a job entry. In general, a job will have a different Index for each node. In cases where a job is represented more than once in a table, a different Index is assigned to each instance.

“Customer ID” identifies the customer for which the job is being performed for environments in which jobs are performed for multiple customers or users. The Customer ID can be used for charging customer accounts and for directing notices of job failures and job completion.

“Batch ID” identifies a batch to which a job belongs. The batch ID can be used to look up a batch file or an entry in a batch database to determine dependencies among jobs in the batch. For example, a scheduler may not schedule a job for execution if it depends on the completion of a failed job for that execution.

The “Originating Node” is the node at which the job was submitted. The “Originating Job ID” is the Index assigned by the originating node when the job was submitted. The Originating Node and Originating Job ID are the same for all entries across nodes and within a node corresponding to a job. Thus, these two fields can be used by duplicate-job removers to detect cases in which a job is represented more than once in a table.

An “Executing Node” is a node on which the job is claimed, i.e., scheduled for execution, or currently executing. This can be the originating node, a node specified upon job submission for execution, a node that has claimed the job, etc. If there are two entries in a table with the same Originating Node and Originating Job ID and different execution nodes, this is an indication that processing effort may be wasted. If a node is one of the executing nodes, it can try to determine whether it should abort execution of the job. The Executing Job ID is the Index assigned to the job by the Executing Node when the job was first received by the Executing Node (through intake or synchronization).

“Status” is the status of the job on the Executing Node. Possible values are “pending”, “running”, “completed”, “aborted”, “failed”, and “pending retry”. “Next Status” can assume the same values, and indicates the next status expected. “Retry Count” indicates the number of retries after failures. If an executing job fails while the retry count is zero, the Status becomes “Pending Retry”, the Next Status becomes “Running”, and the Retry Count increments to “1”. If the job fails again, the Status becomes “pending retry”, the Next Status becomes “Running”, and the Retry Count increments to “2”. If the job fails again, the status and next status are “failed”, and the Retry Count remains at 2. “Aborted” indicates a job that is no longer to be executed by any node, e.g., because it has failed on two nodes.

“Claimed” indicates that the job is claimed by a node. Claim status applies to jobs that have failed on one node; in that case, another node can “claim” the job. The Claimed count indicates the number of times that the job was claimed. A claim count of two can indicate to a duplicate job remover that a conflict exists; the duplicate job remover can then determine whether to abort the job.

“Time Stamp” indicates the most-recent time an update was received for the job record. Periodic updates are transmitted and received for all jobs, even when the status is unchanged. If a time threshold is passed without receiving an update, this can indicate a failed node and trigger a status update that causes the job to be claimed by another node.

“Start Time” indicates when a job started executing. If a job is executing on two nodes, the one with the later start time can abort. “End time” indicates the time when a completed job completed execution. In one mode of operation, End Time can indicate a projected end time while a job is executing. This projection can be based on the elapsed time it took for a portion of an executing job to be processed. In this mode of execution, a node with a later projected end time can be aborted in favor of a node with an earlier projected end time. Using projected end time instead of start time to determine which execution instance to abort has the advantage that the differences in node performance can be taken into account in making such determinations. In general, the job tables can provide implementation-specific fields in addition to or in place of the fields described above. These and other variations upon and modifications to the illustrated embodiment are within the scope of the following claims.

What is claimed is:

1. A method comprising:
a first node of a job-processing network updating a first job database for said first node to indicate that a first job is executing or is about to be executed on said first node; and
synchronizing network nodes so that other nodes of said network not executing said job update their respective job databases to indicate that said first job is executing on said first node.

2. A method as recited in claim 1 further comprising:
said first node detecting that execution of a second job has failed on a second node of said network; and
updating said job database for said second node to indicate that execution of said first job on said first node has failed.

3. A method as recited in claim 2 further comprising said first node executing said second job.

4. A method as recited in claim 3 further comprising said first node determining that said first database indicates that said second job is executing on said first node and at least one other node of said network.

5. A method as recited in claim 4 further comprising said first node aborting execution of said second job.

6. A method as recited in claim 4 further comprising:
said first node predicting whether or not said second job is likely to be completed earlier on another node; and
if said second node determines that said first job is likely to be completed earlier on another node, aborting execution of said second job on said first node.

7. A method as recited in claim 6 wherein said another node is said first node on which execution of said first job has resumed.

8. A method as recited in claim 1 wherein said first job belongs to a batch of jobs including a second job and having associated batch data, said batch data indicating that execution of said second job on a node is not to begin or is to be halted if execution of said first job fails on that node.

9. A method as recited in claim 8 further comprising:
said first node detecting that execution of said first job has failed; and
said first node updating said first job database to indicate that said second job is not to be executed on said first node.

10. A job-processing system comprising computer-readable media encoded with code including computer-executable programs and computer-manipulable data, said code defining
a first job database for listing each job to be processed on a first node of said system and each job to be processed on other nodes of said system and not on said first node, said job database associating each of said jobs with information relating to that job;
a first job intake for receiving jobs to be processed by said system, said job intake entering jobs received by said first job intake into said first job database; and
a first job-database synchronizer for transmitting job-status updates for jobs represented in said first job database to other nodes and for updating said job database in accordance with job-status updates from other nodes.

11. A job-processing system as recited in claim 10 wherein said code further defines:
a first job processor for processing jobs including said first job; and
a scheduler for scheduling at least some of the jobs listed in said first job database for execution by said first job processor.

12. A job-processing system as recited in claim 11 wherein said scheduler provides for scheduling execution of a second job on said first node when said first job database indicates that execution of said second job on a second node of said system has failed.

13. A job-processing system as recited in claim 12 wherein said code further defines a duplicate job remover for monitoring said first job database and for causing abortion of execution of said second job when said first job database indicates that said second job is executing on another node.

14. A job-processing system as recited in claim 12 wherein said first duplicate job remover provides for a prediction whether execution of said second job will complete first on said first node or on another node, and
if said prediction is that said execution will complete first on another node, causing execution of said second job on said first node to abort, and
if said prediction is that said execution will complete first on said first node, continuing execution of said second job on said first node.

15. A job-processing system as recited in claim 14 wherein said another node is said second node on which execution of said second job has resumed.

16. A job-processing system as recited in claim 12 wherein said code indicates that a third job is not to be executed if execution of said first job fails, said first job scheduler not executing or aborting execution of said third job in the event execution of said first job fails.

17. A job-processing system as recited in claim 10 further comprising said first node, said first node including:
one or more processors for executing at least some of said code including said first job processor;
communications devices for use by said first job-database synchronizer for transmitting and receiving job-status updates; and
at least some of said media.
